(19) United States
(12) Patent Application Publication
(10) Pub. No.: US 2013/0291119 A1
(43) Pub. Date: Oct. 31, 2013

(54) PACKAGED DIGITAL RIGHTS MESSAGING

(71) Applicant: ENTHRILL DISTRIBUTION INC., Calgary (CA)

(72) Inventors: Jeff BUICK, Calgary (CA); Kevin FRANCO, Calgary (CA); Nicholas LEBLANC, Calgary (CA); Wayne LOGAN, Calgary (CA); Celia RUSHFORD, Calgary (CA)

(73) Assignee: ENTHRILL DISTRIBUTION INC., Calgary (CA)

(21) Appl. No.: 13/873,002

(22) Filed: Apr. 29, 2013

Related U.S. Application Data
(60) Provisional application No. 61/639,257, filed on Apr. 27, 2012.

(51) Int. Cl. G06F 21/10

(52) U.S. Cl. CPC G06F 21/10
USPC 726/26

(57) ABSTRACT

A method for adding digital personalization to a digital asset is provided. The addition of digital personalization to a digital asset allows a distributor of digital assets to include packaged digital rights messaging to their products. A consumer's personal information is inserted into a scripted message which includes a reminder of their copyright obligation. The personalization can also include an encoded asset identification which is not visible to the casual consumer. The asset is provided without the usual rights management restrictions.

### CROSS-REFERENCE TO RELATED APPLICATION

This application claims the benefit of U.S. Provisional Appl. 61/639,257, filed 27 Apr., 2012, the entirely of which is incorporated herein by reference.

### FIELD

A method is provided for packaging personalized digital rights notification within a digital asset for improving user copyright compliance while reducing reliance and associated barriers associated with digital rights management restrictions.

### BACKGROUND

Traditional Digital Rights Management (DRM) provides for the delivery of a digital asset, including, but not limited to, audio/video/book content over an IP network to a device in such a way that the Distributor can control how that content is used. The device owner typically accepts the contract by acknowledging the Distributor's Terms of Service (TOS) by “clicking” on the appropriate icon on the Distributor's portal. In structuring the acceptance of the TOS in such a manner, the audio/video/book content (the digital asset) is separated from the contractual terms of the TOS. The DRM that controls the digital asset includes an embedded technological restrictive component requiring compliance with the TOS.

Compliance can mean restrictions on copying or include opening, printing or use on other platforms. For example an e-book encoded with DRM for a Kindle™ Reader (Trademark of Amazon.com, Inc.) is restricted from being read on other e-readers.

Publishers and the reading public alike are frustrated and concerned about the restrictions that arise in the digital asset environment that do not exist, or have been long resolved, in the paper-media form of literature.

To date, relevant solutions include removal of DRM in its entirety, or using a form of “social DRM” including watermarking. Watermarking can be visible or hidden. In either case, consumer's information is inserted into the digital asset. The copyright's owner's rights are managed using the consumer's usual reluctance to have their personal information persistent in copies of the asset. However, this reluctance is predicated on an assumption that even the consumer understands that there are restrictions regarding other uses of the asset that they had already agreed to by accepting the distributor's TOS, that the personal information is a pointer to them as the source, and that there is liability associated with improper use of the asset.

However, it is known that watermarking is already readily removed by those who intend to ignore those rights. For the typical consumer, who remains in compliance, the usual DRM restrictions continue to control their behavior, such as in the instances of any exhaustion rights within the second-hand market or even the use of the asset on another of the consumer's own e-readers.

### SUMMARY

In contradistinction to the prior art watermarking techniques, as described herein, embodiments of a Packaged Digital Rights Messaging (PackaDRM) system embed a form of the licensor's TOS within the digital asset without any DRM-restrictive controls. The TOS are presented within the purchased or delivered digital asset in a unique and customizable message that is demonstrably available to the owner or user of the digital asset. The message reminds the user of the TOS, and that their personal identification is associated therewith. Compliance by the user may be likened to acceding to a request by another, being the distributor of the asset. The key is to influence that person into a behavior that they might not otherwise engage. In this case, compliance can be positively influenced when there is something offered, drawing a reciprocal positive response from the purchaser. Here the offer is the removal of rights management restrictions, rendering the asset more intuitive and freely used within the license rights provided, in return for the purchaser's compliance with the more encompassing copyright compliance, such as to refrain from sharing.

One theory of an individual's tendency for self-regulation, which may be applicable in copyright compliance, might be found in the development of a branch of psychology known now as Social Cognitive Theory of Morality. In this area, Albert Bandura (Stanford University) sets forth that an individual, in developing a moral self, adopts standards of right and wrong that serve as a guide and restraint for conduct. Individuals regulate their actions in view of consequences, doing things that provide them satisfaction and sense of self-worth and refraining from behaviors that violate their moral standards in order to avoid self-condemnation, and resulting in an individual's self-regulation.

This self-regulation is achieved, using embodiments of the Digital Rights Management (DRM) tool, by inserting purchaser's information into a digital asset via a digital personalization for the asset and then displaying that information in a unique and customizable message, together with a reminder of their obligations and possible liability if they do not. The message is visible or audible to the purchaser. The purchaser is reminded that they have received a digital asset free of encumbrances, that it has been personalized for them and they alone, that there are obligations and prohibitions associated therewith, and appeals to the purchaser's sense of morality and self-regulation against copyright infringement.

Embodiments of the system introduce a more robust form of social Digital Rights Management (DRM) using a digital personalization technique wherein the consumer's personal information is inserted into a scripted message which is then displayed as a unique and personalized message somewhere inside the digital asset. No longer is it assumed that the purchaser remembers or even read the TOS associated with the initial purchase. In a persuasive manner, and to their immediate benefit upon using their digital asset, the user is introduced or reminded of their obligations and consequences.

Embodiments combine social DRM and personalized and educational form of watermarking, the visible or audible markings serving to remind the purchaser, being a reader/watcher/listener, that the digital asset they have purchased is protected by copyright laws and should not be shared or reproduced.

In one broad aspect, a method is provided for adding digital personalization to a digital asset comprising receiving a customer request for a license to a digital asset and receiving customer identification (CID). The method continues with unpackaging of the asset or acquiring an unpackaged form of the asset. A first personalization notification (PDRN) message is prepared, each PDRN message including a copyright notification and at least one element of the CID and formatting the unpackaged asset to include each PDRN message for sensory display to the customer. One completes the personalization by packaging the formatted unpacked asset with the digital personalization therein, for return to the customer.

### BRIEF DESCRIPTION OF THE DRAWINGS

FIG. 1A is a flowchart illustrating an embodiment of a packaged digital rights messaging system;

FIG. 1B is a continuation flowchart for the step of inserting a CID and PDRN message in a generic asset;

FIGS. 2 to 4 illustrate one example of implementation for an epub ebook, namely

FIG. 2 illustrates an ebook having no watermarks or personalization,

FIG. 3A is a sample introductory personalization message in the form of a page,

FIG. 3B is a sample end personalization message, and

FIG. 4 illustrates the ebook of FIG. 2 with personalization added and a tracking ECID embedded therein;

FIGS. 5A and 5B are examples of one particular embodiment applied to an epub ebook, namely a sampling of an OPF filing a side-by-side illustration of a pre-, and post-PRDN page-form of message NCX file respectively.

### DESCRIPTION OF THE EMBODIMENTS

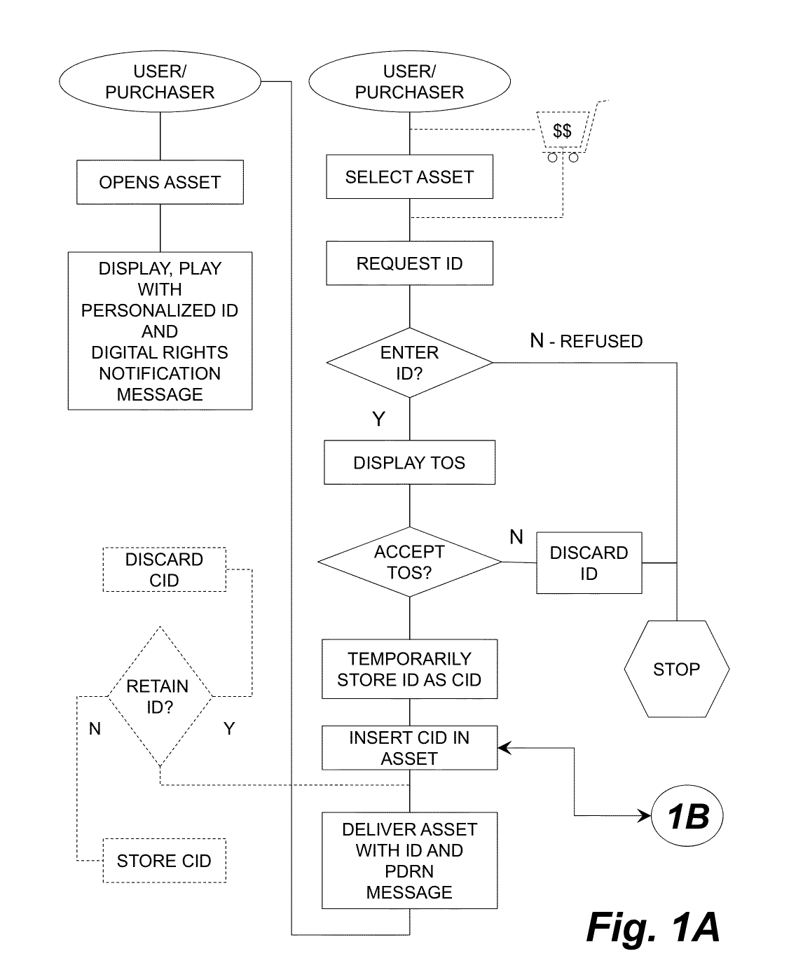

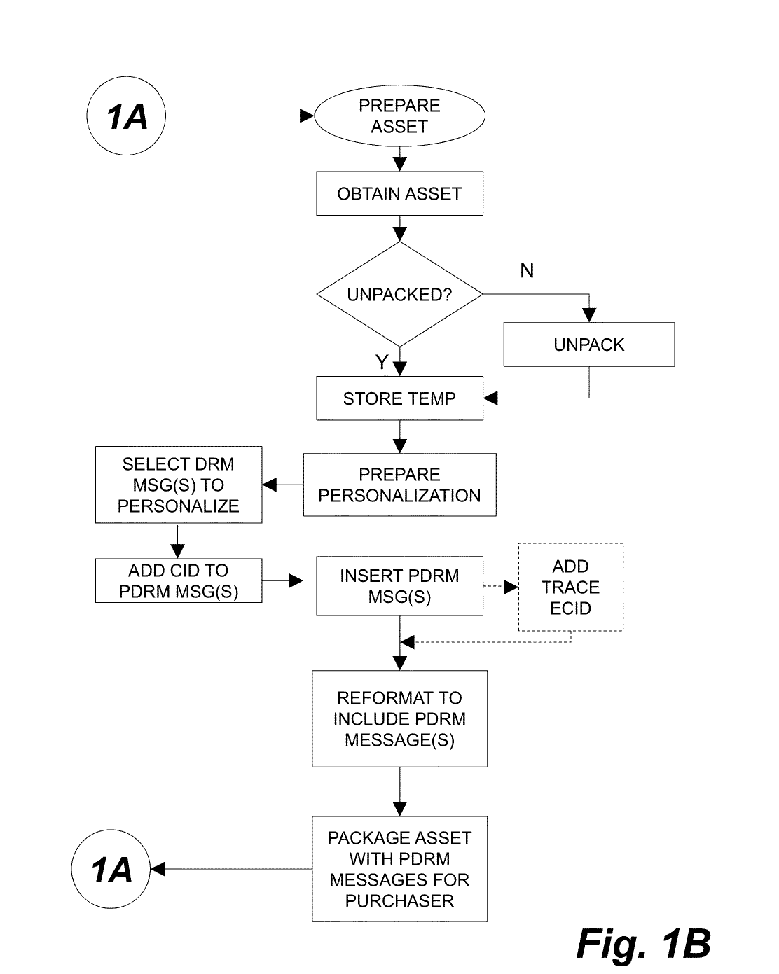

As shown in FIG. 1A, in an embodiment, a consumer typically locates a digital asset through a website or other form of portal implementing a form of shopping cart model including direct websites and other portals including those by Amazon™ (trademark Amazon.com, Inc.) and the application iTunes™ (trademark Apple, Inc.). The consumer initiates the purchase an electronic asset, including, but not limited to, ebooks, videos and audio files through an online catalogue and, at some point, particularly prior to the financial transaction, is prompted to input or confirm their identification (CID), including such elements as their name, e-mail address or both. While the terminology “purchase” is used, the transaction is really one of licensing, not transfer of ownership. The ownership of the asset is not transferred. Should the customer refuse to provide suitable CID, then the transaction ends. The terms of service (TOS) for the selected asset are displayed to the consumer. Typically the TOS are displayed as a scroll through agreement with an agree button. The CID is temporarily stored on the server after the consumer reads and accepts the “Terms and Conditions” and selects the desired platform for delivery. The financial aspects of the transaction are completed.

The consumer's CID or information is then permanently inserted into the digital asset in one or more places.

The digital asset is prepared with personalized digital rights notification or PRDN message. The message can be persistent, or temporary, like a pop-up, and in predetermined or irregular locations.

In the particular embodiment of ebooks, the PRDN message can conveniently and effectively inserted as an additional page or pages adjacent the beginning and at the end of the asset, packaged and delivered to the consumer. The message is provided as a purposeful presentation to the user via sensory display, for example such as visual in an ebook or video and audible in an audio file or video.

For preparation of the asset with PRDN, information is passed from the commercial store application handling the transaction to a DRM application at an application server. The store application, such as an online shopping cart and checkout interface, and DRM application can be operated together or as separate services. The DRM application receives the following identification information from the store application, name, a device ID (DID), an asset identification or asset ID and the purchaser's information CID.

The device ID permits identification of the file format, for example, in the case of ebooks, whether the format is *.mobi, *.epub or other format. The asset ID is a unique identifier that identifies the specific asset for transfer or retrieval from the store application or from the collective or other copyrighted works manager. In the case of an ebook ordered from a portal, or a gift card, the transaction is associated with several possible levels of identification, related to the asset, the purchaser, the transaction identification with the store or some combination thereof. The asset ID can be unique for every transaction. Lastly, the CID is passed for incorporation into the PRDN message such as by showing the customer's email.

When the consumer receives and opens the asset, the consumer's information and a message regarding the copyright, which also includes information regarding the obligations associated therewith and may also include the penalties for violations thereof, is presented in the appropriate sensory form to the consumer, and of course, with the implication to the user that their personal; information would also be presented to any other reader.

In embodiments, where the asset is an e-book, the personalized message can be a page and displayed at about the start of the book or at about the end of the book, or both. A PDRN message, in the context of an ebook is typically a “page” being persistent and appearing at a pre-determined location as an additional page and presented in the same manner during reading. However, other messages can include pop-up messages, being temporary, or an audio clip appearing at some point during the asset's use, even in an ebook depending on the type of digital asset and the display device's characteristics. Similarly, the message can be any of a variety of possible presentation means such as video frame or audio clip relating the PDRN message.

In an ebook, an initial personalized PDRN message can include a page displaying the purchaser's information, a welcome and invitation to enjoy the named asset, and a reminder of the TOS contract that the consumer entered into such as those under international copyright laws. An additional message can be an ending page, and can similarly include the purchaser's information, some form of closing salutation, and a further reminder of the TOS.

In other examples and embodiments, where the asset is a video or a movie, a personalized screen shot is displayed at the start of the movie that includes the purchaser's information and advises the purchaser of the penalties for unauthorized sharing or reproduction. In embodiments, where the asset is an audio file, the PDRN message, advising the purchaser that the audio material enclosed in the file is copyrighted and cannot be shared or reproduced, could be delivered through an oral message or even through visual means such as through accompanying album cover art and the like.

With reference generally to FIG. 1B, to prepare the asset with PRDN, the device ID, asset ID and CID are passed to the DRM application. The DRM application receives a customer request for a license to the digital asset. As stated, the DRM receives the customer identification (CID). The asset is retrieved from the authorized source. If it arrives packed, it is unpackaged to enable insertion of PRDN messages. Thus, once unpackaged or copied from an already unpackaged form of the asset, the unpackaged asset is copied to temporary storage.

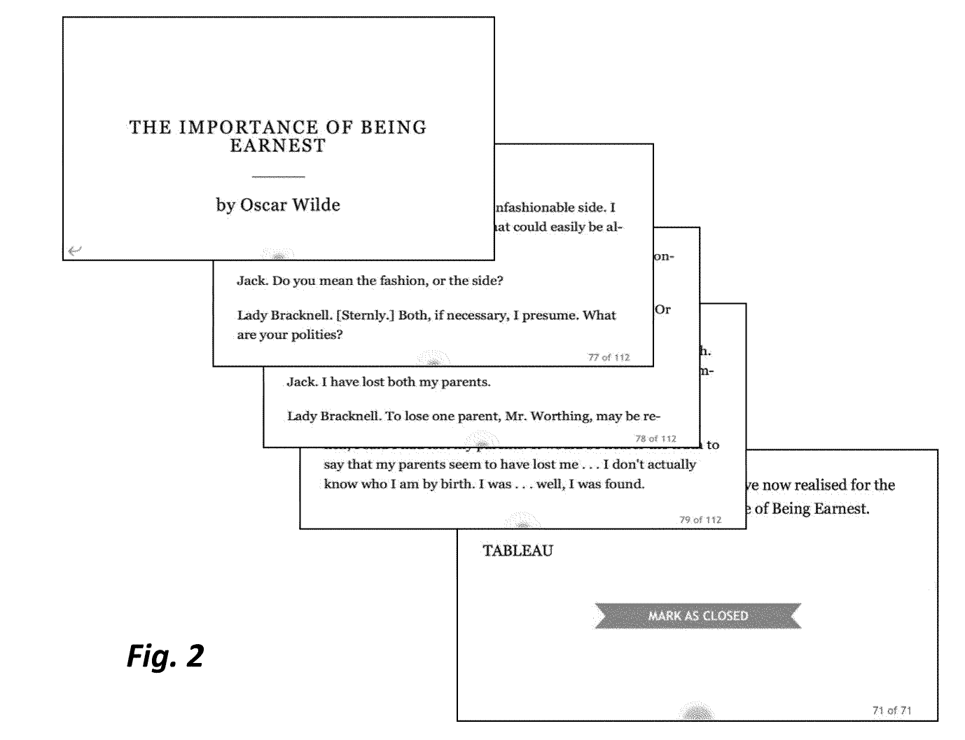

One or more PRDN messages are prepared. The PRDN messages are visible or audible presentations, regardless of the presentation format, being referred to herein as PRDN messages. Herein in FIGS. 2 through 5B, in a example is used where the messages are in the form of pages but, as described above, can also be other forms of communication to the user including pop-ups and audio/visual clips.

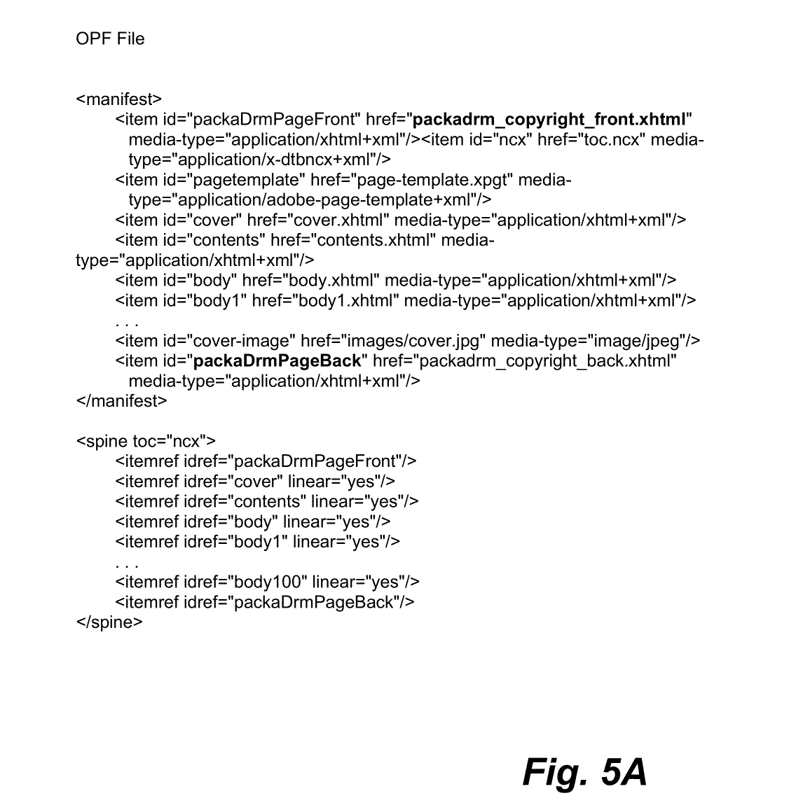

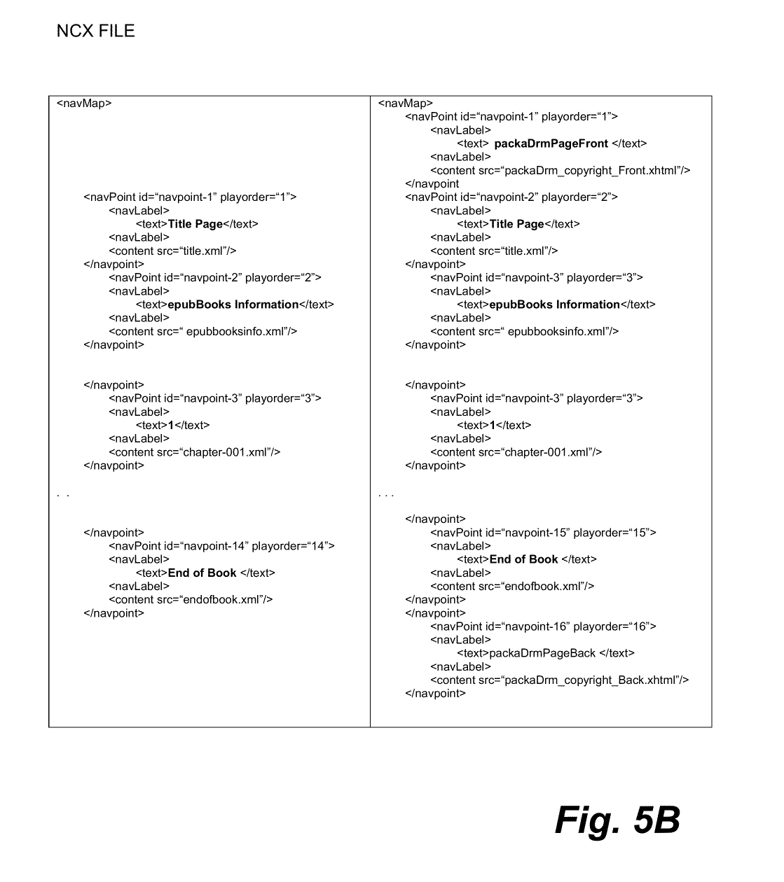

As shown in FIG. 5A, in one ebook embodiment, the unpackaged asset has an open packaging format (OPF) file including a metatag section, a manifest section including the body and pages of the asset, a spine section including a table of contents (TOC), and content documents. The DRM application prepares at least a first personalization notification (PDRN) message such as a PDRN page, each PDRN page including a notification of the TOS and a visual display of at least a portion of the CID, such as an email.

The unpackaged asset is formatted to include each PDRN page.

In one embodiment, the asset is formatted by adding to the metatag section, at least the CID; registering in the manifest section, a reference to each PDRN page; and adding to the spine section, a navigation point to each PDRN page. The pages of the asset are re-sequenced and the TOC re-indexed to include each PDRN page establishing a formatted unpackaged asset. The asset is packaged with the digital personalization therein. For temporary messages such as pop-ups, other elements are arranged in the digital asset and reformatted as necessary to incorporate and interleave same in the normal course of the asset's presentation to the user.

As stated, the PRDN messages pages are a sensory reminder to the user, by reading or hearing. An optional tracking ID or ECID, which is not visible in the normal course of the enjoyment of the asset, can be added to enable tracing if the asset is released for unauthorized distribution. The ECID can be the asset ID, portion thereof or other form of ECID, that can be associated with the actual asset ID in a lookup database including the CID. The ECID can be unique so that if the ECID for one book were identified and located for removal, then it is not a mere matter of locating the same ECID in another digital asset, or even another purchased copy of the same titled asset. This is an additional security feature to aid the asset distributor in locating the source of shared copies while encouraging the distributor to continue to offer traceable, yet DRM-free and copy-restriction free assets.

### EXAMPLE 1

With reference to FIG. 2, in an example of an ebook, with no visible DRM, is illustrated and suitable for the additional of PRDN messages in accordance with embodiments disclosed herein. As shown, there is a title page, some sample pages from one chapter, and an end of book page. The page numbering shown thereon is auto-generated by the device, dependent upon the device, font and device orientation but is consistent once all are determined.

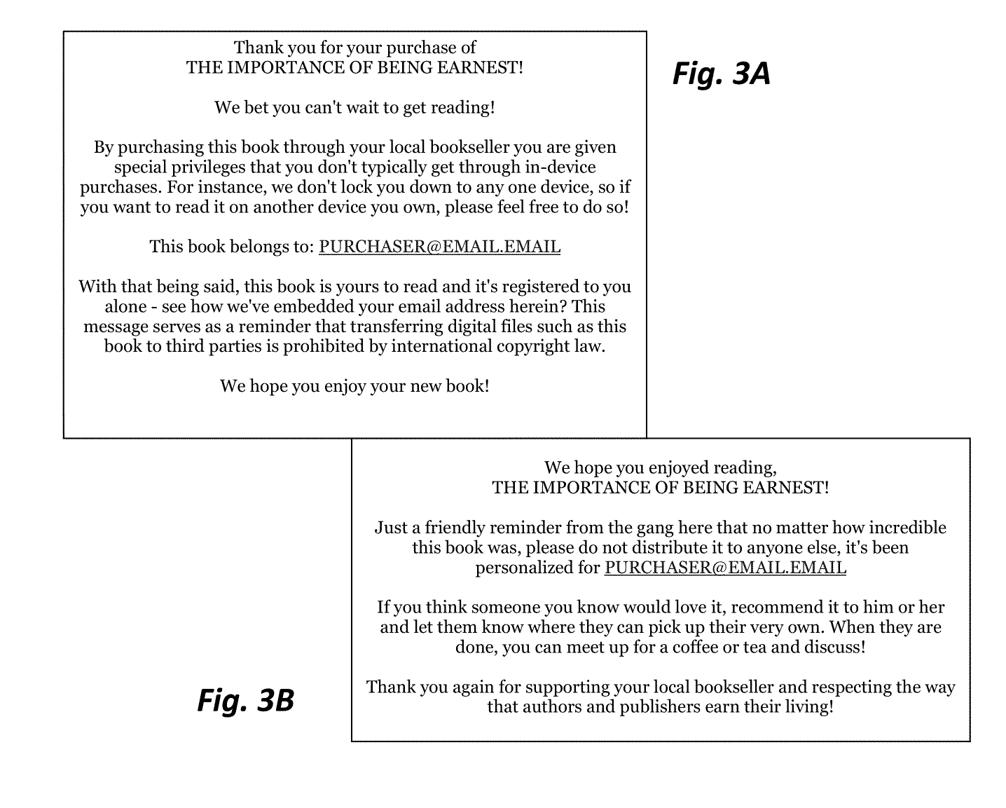

Turning to FIGS. 3A and 3B, sample PRDN messages are prepared. In this example they are prepared as forms of pages for insertion. In this example, the book title and the consumer's CID is embedded or linked—in this case the CID is limited to the consumer's email. Note that the introductory PRDN message of FIG. 3A, is characterized for insertion in the front of the book, including consumer personalization and the reminder DRM notice, and optionally provided with introductory or welcome language, inviting the user to acknowledge the upcoming experience along with the TOS and copyright contract to which they had agreed in making the purchase. The ending PRDN of FIG. 3B, similarly bears the CID and copyright contract reminder but can be optionally context modified to acknowledge a heightened risk of unauthorized distribution once the user has completed their use of the asset.

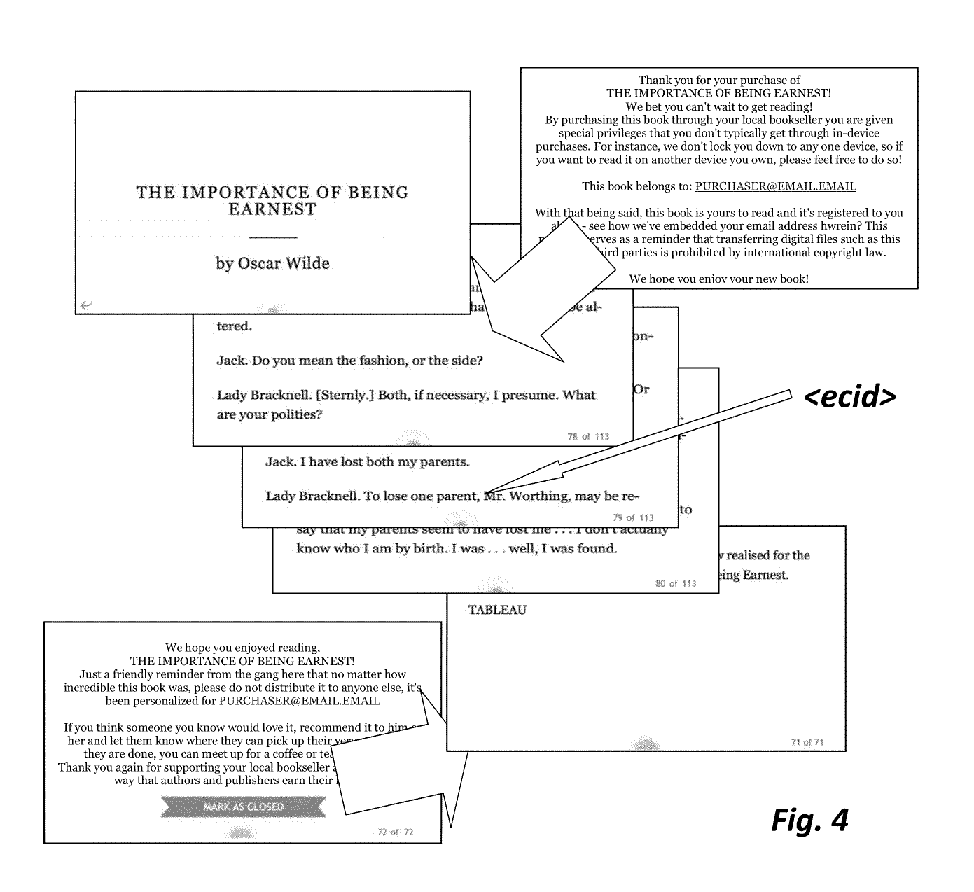

As shown in FIG. 4, the page-form of messages are inserted at the start and at the end of the asset. The starting or front PRDN page might precede the cover page for a substantially unavoidable display, or might follow the cover page. Depending on the location and persistence of insertion and presentation, the table of contents may need revision, and digital pointers updated before repackaging for the consumer. In this example, due to actual insertion of pages, for the last chapter, formerly having a total of 71 pages, is now illustrated as having 72 pages, including an ultimate page bearing the end or back PRDN message page.

As discussed, an ECID can be inserted that will not be visible to the user. The ECID is illustrated fancifully in FIG. 4 as being located at some mid-point of the ebook—the actual insertion being a matter of a variety of possible means of encoding, the particular encoding being device, asset and algorithm dependent, such means being known in the prior art.

As a result, upon opening the ebook, the initial consumer sees the introductory PRDN and is reminded of the DRM contract, and after finishing the ebook, is once again reminded of the DRM contract. Of course, the consumer is also aware that unauthorized copies will also bear the same PRDN.

The ECID enables tracking of the initial consumer transaction. While PRDN pages may be readily removed using tools already available to both authorized and unauthorized technicians alike, the ECID is more overt and more likely to survive the casual editor.

### EXAMPLE 2

In a more detailed example of an epub ebook, and wherein the insertion of PDRN messages as added pages, the unpackaged asset is copied to a temp directory.

As shown in FIG. 5A, the ebook has a typical known format, depending on the intended device or reader. A typical .epub format includes an OPF (Open Packaging Format) file and an NCX file, a separate file in an ebook's folder.

The OPF file contains a package element with child elements for metadata, manifest, spine, and guide. The OPF file is an (x)html or XML file that the device/app first parses, having the metadata element and three substantive sections: the Manifest section, listing of assets and their locations within the file; the Spine, a listing of all HTML files ordered in the order that they should be read into the book; and the NCX file referenced in the spine, an XML file that lists the table of contents in the book.

The metadata element includes information describing the book; the manifest, a list of files in the package; the spine, a list of (x)html documents in reading order; and the guide, an optional list of structural components used by reader software, such as Table of Contents, Introduction, start location, Glossary, and other types of information.

The spine section references the NCX file. The NCX file is referenced twice in the OPF file, once as an item in the manifest tag, which lists files that comprise the eBook and secondly as an attribute of the spine tag, which lists items in their reading order. Such an eBook would also have an HTML Table of Contents, which can be included in the book's HTML file or exist as a separate toc.html file.

The bulk of the NCX file is the collection of navPoint tags used to create various in progress indicators. For example, in Amazon's Kindle™ device the NCX aids in Previewer's NCX View and Progress Bar tick marks. Each NCX navPoint tag includes two child tags: navLabel and Content. The navLabel is title text; the Content tag, a link to the corresponding anchor tag in the book's HTML file or files.

In this embodiment, personalization of the ebook includes modification of the manifest section to include personalization information and register the one or more PRDN pages. The spine is modified to include entries for each added manifest registration. The NCX file is modified to add the path to the added PRDN files. A title is added that will appearing the table of contents or TOC listing.

The NCX and TOC are re-sequenced and the asset re-packaged for delivery to the customer.

In the OPF file, one adds the ECID and asset id to the metadata. Further, one registered pages to be inserted in the Manifest section. With reference to FIG. 5A, the PRDN pages are added as .html files. For each .html PRDN file added to the Manifest, one adds an entry to the Spine using manifest ids.

Further, turning to FIG. 5B, for each .html DRM file added to the Manifest, one adds an entry to the .NCX file using the path of the actual .html PRDN files, see packaDRM_copyright_Front.xhtml. A title, such as “packaDRMPageFront” is provided for each page that shows up in the devices Table of Content (TOC) listing.

Note that the actual entries might vary for differing formats. For example for regular rebook reader files, one might add a single PRDN message before or after the cover and one PRDN message at the end of the book and, in the TOC, list one path/title after the cover and a path/title at the end of the book. In another example, for a current iBooks™ format (Apple, Inc.) one might add one PRDN message at the end of the book with a corresponding path/title at the end of the book. Other formats lend themselves to other arrangements and forms of PRDN messages disclosed herein.

Again, as a page-form of the PDRN message impacts the structure of presentation of an ebook, once the PRDN page or pages are added, one re-sequences the pages and re-indexes the TOC, such as through a modification of the “playorder” in the NCX file. For example, where the original sequence was to the cover having an original playorder=1, then addition of a preceding or front PRDN page changes the sequence so that the PRDN page has playorder=1 and the cover is shifted to playorder=2. Note that playorder is related to page sequence and actual page numbering displayed is dictated dynamically, being display related, device-to-device and further varied by page orientation and choice of font.

Optionally, and typically, an encoded identification ECID is inserted. One can add an ECID xml <meta> entity in the metadata section including, as content, a unique identifier also stored in the system's database related to the specific purchase. Other hacking-resistant encoding methodologies are known to those of skill in the art, for hiding a form of the ECID within the body for better resisting removal.

Once the personalization is complete, and the playorder and TOC are adjusted, the ebook and PRDN pages are packaged for use by the consumer. Again, the packaging is different depending on file format including .mobi,.epub and others.

Returning to FIG. 1A, the packaged ebook can be returned to the store application for upload to the consumer. Alternatively, a link can be provided for download. Once delivered, the file is typically deleted from the temp directory, the retention of same being dependent upon various privacy considerations and requests for retention by the consumer such as for backup or download protection purposes.

Accordingly, upon opening the asset, and upon closing the asset, the purchaser of a PDRN message formatted asset is reminded of their obligations under the TOS originally agreed to when purchasing their digital asset. Further, should the asset appear on a file sharing site, the consumer CID is displayed on the copies, and if the CID is removed, a copy can be unpacked, inspected and an ECID, if any, can be extracted. Where an asset has been infused with PRDN messaging, then the ECID can be looked up in the corresponding database at the DRM application server database for identifying the original consumer.

1. A method for adding digital personalization to a digital asset comprising:
receiving a customer request for a license to a digital asset;
receiving customer identification (CID);
unpackaging the asset or acquiring an unpackaged form of the asset,
preparing at least a first personalization notification (PDRN) message, each PDRN message including a copyright notification and at least one element of the CID;
formatting the unpackaged asset to include each PDRN message for sensory display to the customer;
packaging the formatted unpacked asset with the digital personalization therein.

2. The method of claim 1 wherein the sensory display is one or more of visual and auditory.

3. The method of claim 1 wherein the digital asset is selected from the group consisting of an ebook, video and audio asset.

4. The method of claim 1 wherein
the asset is an ebook; and
one or more of the PDRN messages is a visual sensory display.

5. The method of claim 1 wherein the asset is an ebook and the step of preparing at least a first PDRN message further comprises:
preparing a first PDRN message as an introductory PDRN page for addition and display adjacent a beginning of the asset, and
preparing a second ending PDRN message as a back PDRN page for addition and display adjacent an end of the asset.

6. The method of claim 1 wherein prior to packaging the unformatted digital asset, further comprising encoding a asset identification within the unpackaged asset.

7. The method of claim 1 wherein:
the digital asset is an ebook, the unpackaged asset having an open packaging format (OPF) file including at least a metatag section, a manifest section including the body and pages of the asset, a spine section including a table of contents (TOC), and content documents; and further comprising
formatting the unpackaged asset to include each PDRN message including adding an internal navigation point to include each PDRN message and re-sequencing and re-indexing the asset to include each PDRN message for establishing a formatted unpackaged asset.

8. The method of claim 7 wherein the PDRN message is a page and formatting the unpackaged asset to include each PDRN message further comprises:
adding to the metatag section, at least an asset ID;
registering in the manifest section, a reference to each PDRN page; and
adding to the spine section, a navigation point to each PDRN page, and
re-sequencing the page and re-indexing the TOC to include each PDRN document establishing a formatted unpackaged asset.

9. The method of claim 8 wherein the step of preparing at least a first PDRN message further comprises:
preparing a first PDRN message as an introductory PDRN page and adding, to the spine section, a navigation point to the introductory PDRN page at the beginning of the asset, and
preparing a second ending PDRN message as a back PDRN page and adding, to the spine section, a navigation point to the back PDRN page at the end of the asset.

10. The method of claim 9 wherein:
the introductory PDRN page comprises a title of the asset, a display of the CID and the copyright notification.

11. The method of claim 9 wherein:
the ending PDRN page comprises the title of the asset, a display of the CID and the copyright notification.

12. The method of claim 1 wherein the step of receiving the CID further comprises receiving device identification (DID).

13. The method of claim 1 further comprising:
encoding the CID; and
embedding the encoded CID covertly into the body of the asset.

14. The method of claim 1 wherein each PDRN message further comprises asset-specific content.

15. The method of claim 1 wherein the CID comprises a customer email address.

16. The method of claim 1 further comprising:
receiving the customer request for the asset and the CID at an application server and, at the application server;
obtaining the asset and temporarily storing the unpackaged asset;
formatting the unpackaged asset to include a PDRN message or messages;
packaging the formatted unpacked asset for establishing a packaged asset;
uploading the formatted packaged asset to the customer; and
deleting the formatted packaged asset.

17. The method of claim 16 wherein before formatting the unpackaged asset, further comprising:
requesting the customer's acceptance of the asset's terms of service (TOS); and
if the TOS are accepted, proceeding to formatting the unpackaged asset.

18. The method of claim 1 wherein the step of receiving the CID further comprises:
receiving a DID; and
where the asset is a device-specific asset, adding only those PDRN messages specific to the device-specific asset.
